(19) United States
(12) Patent Application Publication
(10) Pub. No.: US 2015/0054847 A1
(43) Pub. Date: Feb. 26, 2015

(54) STATUS DISPLAY CONTROLLER, STATUS DISPLAY CONTROL METHOD, AND RECORDING MEDIUM THAT STORES PROGRAM

(71) Applicant: P&W Solutions Co., Ltd., Tokyo (JP)

(72) Inventor: Toshiyuki OMIYA, Tokyo (JP)

(21) Appl. No.: 14/459,648

(22) Filed: Aug. 14, 2014

(30) Foreign Application Priority Data
Aug. 21, 2013 (JP) 2013-171418

(51) Int. Cl. G09G 5/02

(52) U.S. Cl. CPC G09G 5/02
USPC 345/589

(57) ABSTRACT

The tier designation unit 41 designates tiers of time units that are tiered such that a predetermined tier is composed of N time units of the lower tier. The status acquisition unit 42 acquires real status for each time unit of the tier designated by the tier designation unit 41. The display form determination unit 43 determines a display form of an item for each time unit of the tier designated by the tier designation unit 41, based on difference between the real status and the ideal status acquired by the status acquisition unit 42, and based on display forms of N items of the lower tier. The display control unit 44 executes control such that each item for each time unit of the tier designated by the tier designation unit 41 is displayed in the display form determined by the display form determination unit 43.

This application is based on and claims the benefit of priority from Japanese Patent Application No. 2013-171418, filed on 21 Aug. 2013, the content of which is incorporated herein by reference.

### BACKGROUND OF THE INVENTION

1. Field of the Invention

The present disclosure relates to a status display controller, a status display control method, and a recording medium that stores a program.

2. Related Art

Various work management devices have been developed for the purpose of improving efficiency in management of workers' working status. In order to improve the efficiency in such management of working status, a device has been disclosed which calculates difference in time between schedule (ideal status) and result (real status) of a worker, and which displays a numerical value in “minutes” as the calculated difference in time.

However, since only the numerical value of the difference in time is displayed, an administrator has not been able to intuitively and immediately understand how the real status specifically differs from the ideal status.

### SUMMARY OF THE INVENTION

A status display controller for executing control of displaying real status for respective items time-divided on the basis of a predetermined time unit is provided with a tier designation unit, a status acquisition unit, a display form determination unit, and a display control unit. The tier designation unit designates a tier of time units that are tiered such that a predetermined tier is composed of N time units of a lower tier. The status acquisition unit acquires real status for each time unit of the tier designated by the tier designation unit. The display form determination unit determines a display form of an item for each time unit of the tier designated by the tier designation unit, based on difference between the real status and ideal status acquired by the status acquisition unit, and based on display forms of N items of a lower tier. The display control unit executes control such that each item for each time unit of the tier designated by the tier designation unit is displayed in the display form determined by the display form determination unit.

A status display control method, which is executed by a status display controller for executing control of displaying real status for respective items time-divided on the basis of a predetermined time unit, includes a tier designating step, a status acquiring step, a display form determining step, and a display controlling step. The tier designating step designates a tier of time units that are tiered such that a predetermined tier is composed of N time units of a lower tier. The status acquiring step acquires real status for each time unit of the tier designated in the tier designating step. The display form determining step determines a display form of an item for each time unit of the tier designated in the tier designating step, based on difference between the real status and ideal status acquired in the status acquiring step, and based on display forms of N items of a lower tier. The display controlling step executes control such that each item for each time unit of the tier designated in the tier designating step is displayed in the display form determined in the display form determining step.

A recording medium storing a program for causing a computer, which executes control of displaying real status for respective items time-divided on the basis of a predetermined time unit, to function as a tier designation unit, a status acquisition unit, a display form determination unit, and a display control unit. The tier designation unit designates a tier of time units that are tiered such that a predetermined tier is composed of N time units of the lower tier. The status acquisition unit acquires real status for each time unit of the tier designated by the tier designation unit. The display form determination unit determines a display form of an item for each time unit of the tier designated by the tier designation unit, based on difference between the real status and ideal status acquired by the status acquisition unit, and based on display forms of N items of a lower tier. The display control unit executes control such that each item for each time unit of the tier designated by the tier designation unit is displayed in the display form determined by the display form determination unit.

### BRIEF DESCRIPTION OF THE DRAWINGS

FIG. 1 is a block diagram showing a hardware configuration of a status display controller according to an embodiment of the present disclosure;

FIG. 2 is a functional block diagram showing a functional configuration for executing status display control processing, among functional configurations of the status display controller;

FIG. 3 is a diagram showing an example of a display image that is displayed under control of the status display controller shown in FIG. 2;

FIG. 4 is a flowchart showing a flow of the status display control processing to be executed by the status display controller of FIG. 1 having the functional configuration of FIG. 2; and

FIG. 5 is a flowchart showing a flow of pre-display processing to be executed by the status display controller of FIG. 1 having the functional configuration of FIG. 2.

### DETAILED DESCRIPTION OF THE INVENTION

An embodiment of the present disclosure is hereinafter described with reference to the drawings.

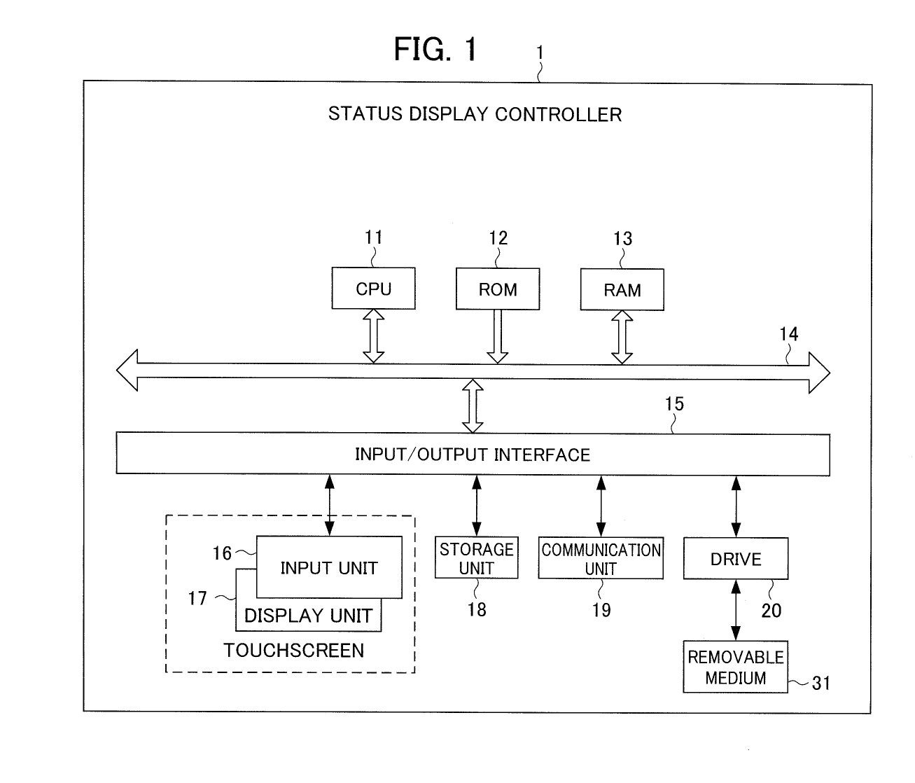

FIG. 1 is a block diagram showing a hardware configuration of a status display controller according to one embodiment of the present disclosure.

A status display controller 1 includes: a CPU (Central Processing Unit) 11, ROM (Read Only Memory) 12, RAM (Random Access Memory) 13, a bus 14, an input/output interface 15, an input unit 16, a display unit 17, a storage unit 18, a communication unit 19, and a drive 20.

The CPU 11 executes various types of processing in accordance with programs recorded in the ROM 12 or programs loaded into the RAM 13 from the storage unit 18.

The RAM 13 appropriately stores data, etc. required for the CPU 11 to execute various types of processing.

The CPU 11, the ROM 12 and the RAM 13 are mutually connected via the bus 14. The input/output interface 15 is also connected to the bus 14. The input unit 16, the display unit 17, the storage unit 18, the communication unit 19 and the drive 20 are connected to the input/output interface 15.

The input unit 16 is configured by, for example, a capacitive or resistive position input sensor which is laminated on a display area of the display unit 17, and detects coordinates of a position where a touch operation has been performed. Here, the touch operation refers to an operation of an object (a user's finger, stylus or the like) to touch or approach the input unit 16. The position where a touch operation is performed is hereinafter referred to as “touch position”; and coordinates of the touch position are hereinafter referred to as “touch coordinates”.

The display unit 17 is configured by a display to display various images.

More specifically, in the present embodiment, a touchscreen is configured by the input unit 16 and the display unit 17.

The storage unit 18 is configured by a hard disk or DRAM (Dynamic Random Access Memory), and stores data of various images.

The communication unit 19 controls communication with other devices (not shown) via networks including the Internet.

A removable medium 31 is mounted to the drive 20 as appropriate. The removable medium 31 is composed of a magnetic disk, an optical disk, a magneto-optical disk, semiconductor memory, or the like. The drive 20 reads a program(s) from the removable medium 31. The program(s) is installed in the storage unit 18 as necessary. Similar to the storage unit 18, the removable medium 31 can also store a variety of data such as image data stored in the storage unit 18.

The CPU 11 of the status display controller 1 with such a configuration determines each display form for each item segmented on the basis of a predetermined time unit of a predetermined tier, based on difference between real status (result) and ideal status (schedule) of each item of the predetermined tier, and based on a display form corresponding to each item of a lower tier. The CPU 11 displays each item of the predetermined tier in each determined display form. Such a sequence of processing is hereinafter referred to as “status display control processing”.

Descriptions are hereinafter provided for a functional configuration for executing the status display control processing.

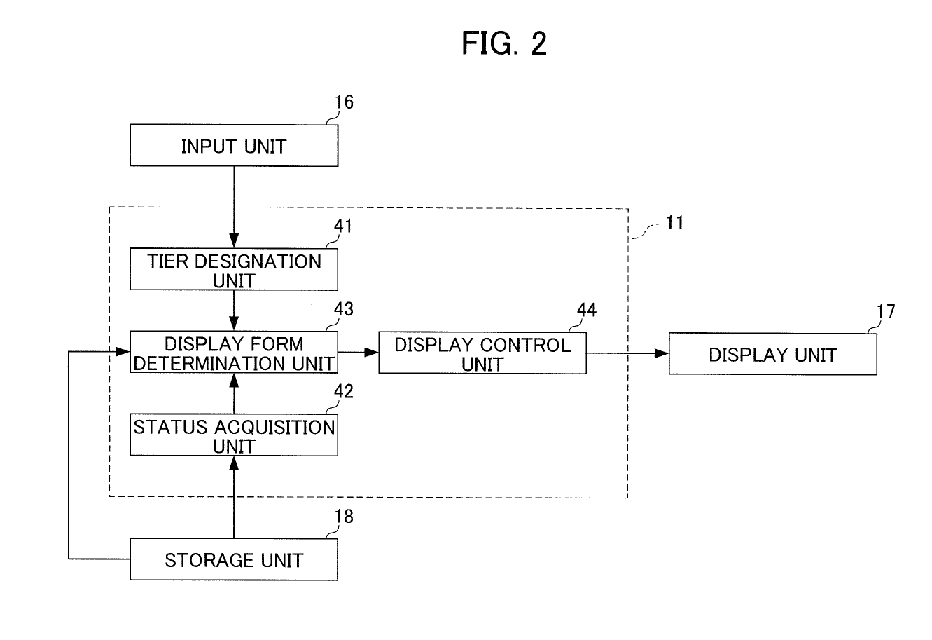

FIG. 2 is a functional block diagram showing a functional configuration for executing the status display control processing, among functional configurations of the status display controller 1 shown in FIG. 1.

A tier designation unit 41, a status acquisition unit 42, a display form determination unit 43, and a display control unit 44 function when the CPU 11 controls the execution of the status display control processing.

The tier designation unit 41 to the display control unit 44 functioning by the CPU 11 are only examples. In other words, at least some of the functions of the tier designation unit 41 to the display control unit 44 can also be assigned to components other than the CPU 11 (for example, a special purpose processor for image processing, etc. (not shown)).

The tier designation unit 41 designates a tier Ms to be displayed, for which instruction is provided through an operation of the input unit 16 by the user.

The status acquisition unit 42 acquires real status for each time unit of the tier Ms designated by the tier designation unit 41.

Here, the real status refers to actual status in relation to the ideal status, and shows a result representing achievement or performance that is brought about by actual human behavior, in the present embodiment. More specifically, in the present embodiment, status of whether an operator is actually sitting is employed as real status; information showing such status (hereinafter referred to as “real status information”) is acquired in advance; and the real status is defined on the basis of the real status information.

In the present embodiment, whether an operator is actually sitting is detected for each minimum time unit (for example, one minute), in which the real status information is “1” when the operator is actually sitting, and the real status information is “0” when the operator is not actually sitting.

A technique for detecting whether an operator is actually sitting is not particularly limited. The technique for detecting whether an operator is actually sitting may, for example, be a detection technique based on report information that is input through a terminal operation by the operator; or alternatively, may be a detection technique based on an output of a sensor attached to a chair or terminal that is used by the operator at work.

As ideal status, the present embodiment employs status showing a schedule of human behavior that is not yet achieved in reality, but is prospectively defined as achievable. More specifically, in the present embodiment, ideal status is classified roughly into: status prospectively defined as time when an operator is supposed to take a break (schedule for intermission); and status prospectively defined as time when the operator is supposed to sit at work (schedule for working hours).

In the present embodiment, it is assumed that an operator can freely choose whether to sit during the schedule for intermission, which is counted as having no difference from the real status. In other words, in the present embodiment, ideal status is when an operator is sitting during the schedule for working hours, in which difference from the real status (whether the operator is actually sitting) is counted.

In the present embodiment, time units for expressing difference between the ideal status and the real status are tiered. A time unit of the lowermost tier (the lowermost tier is hereinafter referred to as “Mmin tier”) is a minimum unit (for example, one minute) for detecting whether an operator is actually sitting. A time unit of the M^{th} tier (M is an integer value of at least 2) is composed of N time units (N is an integer value of at least 2) of the next tier below (M^{-1th} tier).

In order to facilitate understanding of the present disclosure, only two tiers are illustrated in the following descriptions, in which the time unit of the first tier (Mmin tier) is one minute. The time unit of the second tier is fifteen minutes (N=15) in relation to the time unit of the first tier (Mmin tier).

The time unit can be freely set, based on an operation of the input unit 16 by an administrator or the like.

The display form determination unit 43 determines a display form of an item for each time unit of the tier Ms designated by the tier designation unit 41, based on difference between the real status and the ideal status acquired by the status acquisition unit 42, and based on display forms of N items of the lower tier (M^{-1th tier).}

Here, an item refers to a display object showing a time unit of the tier Ms designated to be displayed. For example, in the present embodiment, a rectangular display object is employed.

More specifically, in the present embodiment, the display form determination unit 43 firstly sets the Mmin tier (lowermost tier) to a counter M. The display form determination unit 43 determines a display form of each item of the Mmin tier (lowermost tier) being set to the counter for each time unit, based on whether the real status information and the ideal status information acquired by the status acquisition unit 42 coincide with each other.

Regarding the status during the working hours in the ideal status, in a case in which the real status information of a predetermined item of the Mmin tier (lowermost tier) is “0” (on a 1-minute basis), the display form determination unit 43 determines that the operator is actually away from the desk, i.e. the real status and the ideal status do not coincide with each other, and calculates the difference between the ideal status and the real status of the item as “1”.

The display form determination unit 43 determines one value from among binary gray scales, as a display form of the item. Here, for example, the display form determination unit 43 determines “black” from among binary values of “black” and “white”.

Therefore, in a case here in which the predetermined item of the Mmin tier (lowermost tier) is displayed in “black”, the administrator can intuitively and immediately understand that the real status and the ideal status do not coincide with each other during the time (one minute) corresponding to the item, i.e. the operator is actually away from the desk (which is the real status) despite the fact that the operator is supposed to be sitting (which is the ideal status).

In contrast, regarding the status during working hours in the ideal status, in a case in which the real status information of a predetermined item of the Mmin tier (lowermost tier) is “1” (on a 1-minute basis), the display form determination unit 43 determines that the operator is actually sitting, i.e. the real status and the ideal status coincide with each other, and calculates the difference between the ideal status and the real status of the item as “0”.

The display form determination unit 43 determines the other value from among the binary gray scales, as a display form of the item. Here, for example, the display form determination unit 43 determines “white” from among the binary values of “black” and “white”.

Therefore, here, in a case in which the predetermined item of the Mmin tier (lowermost tier) is displayed in “white”, the administrator can intuitively and immediately understand that the real status and the ideal status coincide with each other during the time (one minute) corresponding to the item, i.e. the operator is actually sitting (which is the real status), while the operator is supposed to be sitting (which is the ideal status).

As described above, in the present embodiment, regarding the status during the intermission in the ideal status, the ideal status and the real status are treated as having no difference (i.e. coinciding with each other). More specifically, regarding each item of the Mmin tier (lowermost tier) during the intermission (on a 1-minute basis), the display form determination unit 43 determines the difference between the ideal status and the real status as “0” in a single uniform way. The display form determination unit 43 determines “white” from among the binary values of “black” and “white”.

Here, in a case in which the tier Ms designated to be displayed is the second tier (Mmin tier+1=the next tier above the lowermost tier), the display form determination unit 43 increments the counter M by 1, and determines a display form of each item of the upper tier (M=2) for each time unit (here, the time unit is 15 minutes), based on the difference between the real status information and the ideal status information, and based on the display forms of the N items of the lower tier (the M^{-1th} tier).

More specifically, for example, it is assumed that 6 items are “black” and 9 items are “white” as the display forms of the items (N=15) of the lower tier (here, the Mmin tier (lowermost tier)) corresponding a predetermined item of the upper tier (M=2).

In this case, among the total number N=15 of the items of the lower tier, “ 6/15” as a specific ratio of the items displayed in “black” as the display form in the lower tier corresponds to the difference between the real status information and the ideal status information regarding the predetermined items of the upper tier (M=2).

Therefore, in this case, the display form determination unit 43 determines, for example, a display form represented by a gray scale of “ 6/15”, i.e. “40%”, as the display form of the upper tier (M=2).

Upon receiving data of the display form from the display form determination unit 43, the display control unit 44 executes control such that each item for each time unit of the tier Ms designated by the tier designation unit 41 is displayed in the display form determined by the display form determination unit 43.

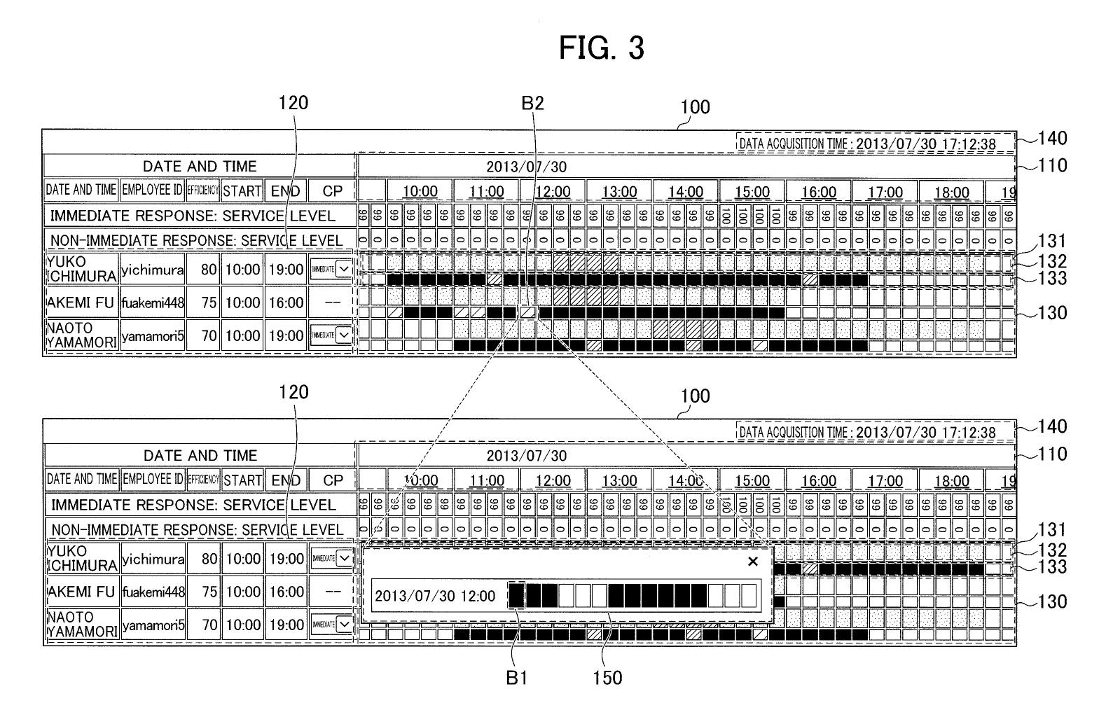

Here, with reference to FIG. 3, descriptions are provided for an example of a display image including each item for each time unit of the designated tier Ms.

FIG. 3 is a diagram showing an example of a display image displayed on the display unit 17 under the control of the display control unit 44.

As shown in FIG. 3, a display image 100 is composed by including: a date-and-time display area 110, a name display area 120, a graph display area 130, and an acquired-time display area 140.

In the date-and-time display area 110, the time units composed of date and time worked by an operator, who is managed by the user (administrator), are displayed in columns at an equal interval for each item.

In the name display area 120, the name of an operator managed by the user (administrator), the ID of the operator, and start time and end time of the working hours of the operator are displayed as multiple items for each operator.

A plurality of status display areas 131 for each operator name displayed in the name display area 120 are displayed in the graph display area 130.

Here, for convenience sake, each of the status display areas 131 is composed by including an ideal status area 132 and a real status area 133 for the second tier (the next tier above the Mmin (lowermost) tier).

Ideal status (schedule) of an operator, whose name is displayed in the name display area 120, is displayed in the ideal status area 132 for each time unit (here, 15 minutes) of the second tier. Here, status (intermission status), which is prospectively defined as time when an operator is supposed to take a break, is displayed in “white”. On the other hand, status (working status), which is prospectively defined as time when an operator is supposed to work, is displayed in “black”.

The actual status (result) of an operator, whose name is displayed in the name display area 120, is displayed in the real status area 133, for each item B1 of the time unit (here, 15 minutes) of the second tier. Here, each item B1 is displayed in a display form determined by the display form determination unit 43, in a predetermined gray scale in this case as described above.

Here, it is assumed that the user (administrator) performs a touch operation on a predetermined item B1 in the real status area 133. In this case, the lower tier (which is the M^{-1th} tier, and is the Mmin tier (lowermost tier) here) corresponding to the item B1 is designated as the tier Ms to be displayed.

Accordingly, the display control unit 44 displays a detailed window 150 as a popup including each item B2 of the items (N=15) of the lower tier (which is the M^{-1th} tier, and is the Mmin tier (lowermost tier) here) corresponding to the item B1.

As described above, each item B2 (N=15) of the Mmin tier (lowermost tier) is displayed in “white” or “black”.

In this manner, when the user (administrator) wishes to see an outline of how the real status of a predetermined operator specifically differs from the ideal status, i.e. how long the predetermined operator is away from the desk during the working hours, the user only has to see the predetermined items B1 in the real status area 133 of the second tier. The display form of the predetermined item B1 in the real status area 133 of the second tier is represented by gradation in gray scales; therefore, the user (administrator) can intuitively and immediately understand how long a predetermined operator is away from the desk during the working hours, on a 15-minute basis (the time unit of the second tier), by only viewing the gray scale of the predetermined item B1.

Furthermore, when the user (administrator) wishes to minutely understand how the real status of a predetermined operator specifically differs from the ideal status, i.e. how long the predetermined operator is away from the desk during working hours, the user only has to perform a simple and intuitive touch operation on the item B1 to designate the lower tier of the second tier, i.e. the Mmin tier (lowermost tier). As a result, as described above, each item B2 (N=15) of the lower tier (which is the M^{-1th} tier, and is the Mmin tier (lowermost tier) here) corresponding to the item B1 is displayed in “white” or “black”. The user (administrator) can intuitively and immediately understand how long a predetermined operator is away from the desk during the working hours, on a 1-minute basis (the time unit of the Mmin tier (lowermost tier)), only by viewing the distribution of “white” or “black” in each of the fifteen items B2.

The time when the real status information and the ideal status information are newly acquired, i.e. the time when the real status information and the ideal status information are updated, is displayed in the acquired-time display area 140.

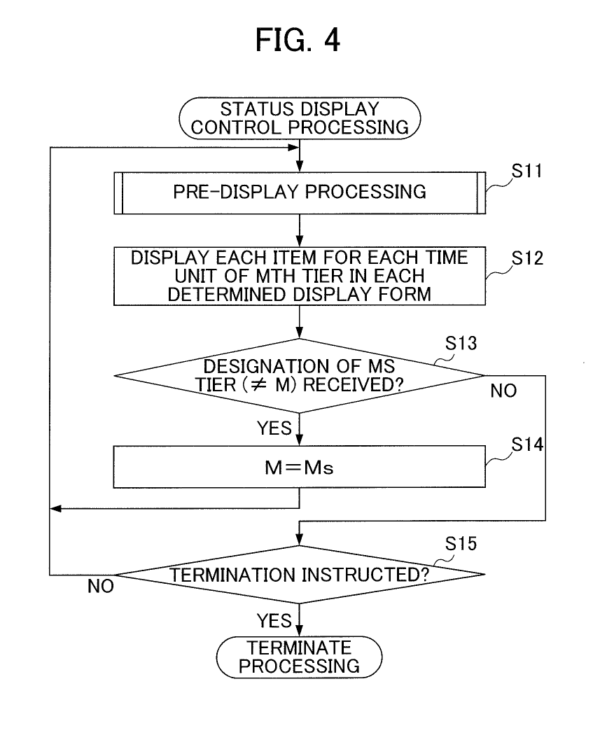

Next, with reference to FIG. 4, descriptions are provided for the status display control processing to be executed by the status display controller 1 having the functional configuration shown in FIG. 2.

FIG. 4 is a flowchart showing a flow of the status display control processing to be executed by the status display controller 1 of FIG. 1 having the functional configuration of FIG. 2.

The status display control processing is initiated, for example, when the real status information and the ideal status information are updated, in which the following processing is executed.

At first, in Step S11, the display form determination unit 43 determines a display form for each item of the designated tier Ms. Here, for example, a value of the uppermost tier (the second tier in the above example) can be employed as an initial value of the designated tier Ms, i.e. a value in the first loop.

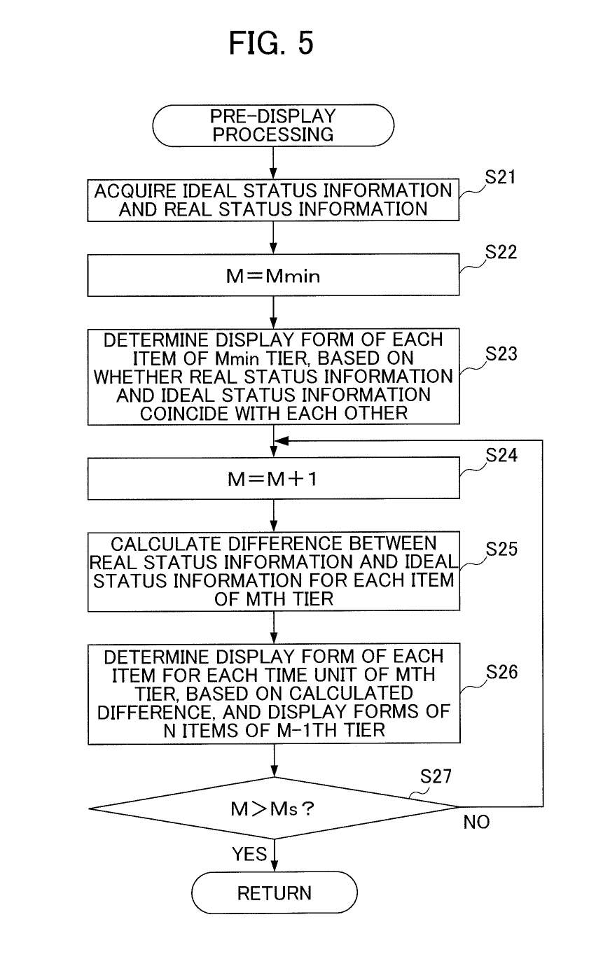

Such processing in S11 is hereinafter referred to as “pre-display processing”. Details of the pre-display processing will be described later with reference to FIG. 5.

In Step S12, the display form determination unit 43 displays each item for each time unit of the M^{th} tier in the determined display form.

In Step S13, the tier designation unit 41 determines whether designation of the Ms tier is received through an operation of the input unit 16 from the user.

In a case in which designation of the Ms tier is not received, the determination in Step S13 is NO, and the processing advances to Step S15. Processing in and after Step S15 will be described later.

In a case in which designation of the Ms tier is received, the determination in Step S13 is YES, and the processing advances to Step S14.

In Step S14, the tier designation unit 41 sets the Ms tier designated in Step S13 to the counter M.

When this processing is completed, the processing returns to Step S12. In other words, the processing in Steps S12 to S14 is repeated until designation of a tier is received; and when designation of a tier is received, each item for each time unit of the designated tier Ms is displayed in the determined display form.

In Step S15, the tier designation unit 41 determines whether a termination instruction is received.

In a case in which a termination instruction is not received, the determination in Step S15 is NO, and the processing returns to Step S12. In other words, the processing in Steps S12 to S15 is repeated until designation of a tier is received; and each item for each time unit of the tier Ms designated last is continuously displayed in the determined display form.

On the other hand, in a case in which a termination instruction is received, the determination in Step S15 is YES, and the status display control processing is terminated.

Next, with reference to FIG. 5, descriptions are provided for the pre-display processing to be executed in Step S11 of FIG. 4 by the status display controller 1 having the functional configuration shown in FIG. 2.

FIG. 5 is a flowchart showing a flow of the pre-display processing to be executed by the status display controller 1 of FIG. 1 having the functional configuration of FIG. 2.

In Step S21, the status acquisition unit 42 acquires ideal status information and real status information (here, on a 1-minute basis).

In Step S22, the tier designation unit 41 sets a value Mmin of the lowermost tier to the counter M.

In Step S23, the display form determination unit 43 determines a display form of each item of the Mmin tier, based on whether the real status information and the ideal status information coincide with each other.

In Step S24, the display form determination unit 43 increments the counter M by 1.

In Step S25, the display form determination unit 43 calculates difference between the real status information and the ideal status information for each item of the M^{th} tier.

In Step S26, the display form determination unit 43 determines a display form of each item for each time unit of the M^{th} tier, based on the calculated difference, and based on the display forms of the N items of the M^{-1th} tier.

In Step S27, the display form determination unit 43 determines whether the counter M exceeds the designated tier Ms.

In a case in which the counter M does not exceed the designated tier Ms, the determination in Step S27 is NO, and the processing returns to Step S24. In other words, the processing in Steps S24 to S27 is repeated until a display form of each item of the designated tier Ms is determined.

In this manner, in the above-mentioned example, only two tiers have been described for convenience sake; however, three or more tiers can be used as well.

A case in which the counter M has exceeded the designated tier Ms means that the display form for each item of the designated tier Ms has been determined; therefore, the determination in Step S27 is YES, and the pre-display processing is terminated.

In the present embodiment, the pre-display processing for a display form for each item is executed as pre-processing for display; however, it is not limited thereto, and the processing can be executed at arbitrary timing, such as at an initial session to execute the processing for all the tiers, etc.

As described above, the status display controller 1 executes control of displaying real status for respective items time-divided on the basis of a predetermined time unit, and is provided with the tier designation unit 41, the status acquisition unit 42, the display form determination unit 43, and the display control unit 44.

The tier designation unit 41 designates a tier of time units that are tiered such that a predetermined tier is composed of N time units of the lower tier.

The status acquisition unit 42 acquires real status for each time unit of the tier designated by the tier designation unit 41.

The display form determination unit 43 determines a display form of an item for each time unit of the tier designated by the tier designation unit 41, based on difference between the real status and the ideal status acquired by the status acquisition unit 42, and based on display forms of N items of the lower tier.

The display control unit 44 executes control such that each item for each time unit of the tier designated by the tier designation unit 41 is displayed in the display form determined by the display form determination unit 43.

As a result, an administrator or the like can easily understand a status outline of the lower tier, simply by seeing the status display of the predetermined tier, without seeing the status display of the lower tier. In other words, the administrator or the like can intuitively and immediately understand how the real status specifically differs from the ideal status.

Furthermore, the display forms are represented in gray scales by the status display controller 1. The display form determination unit 43 determines any one value from among the binary gray scales showing whether the real status coincides with the ideal status for the items of the lowermost tier; and determines a gray scale for an item of a predetermined tier, based on incorporation of each gray scale of N items of the lower tier.

As a result, the display form of items of a predetermined tier is represented in a gray scale; therefore, gradation expression is allowed for each status, and visual recognition is facilitated for a user (administrator). In other words, the administrator or the like can understand how the real status specifically differs from the ideal status, even more intuitively and immediately.

The present disclosure is not limited to the abovementioned embodiment; and alterations, improvements, etc. within a scope that can achieve the object of the disclosure are included in the present disclosure.

In the abovementioned embodiment, the tier designation unit 41 receives a touch operation on the input unit 16 configured by a touchscreen; however, the present disclosure is not limited thereto. For example, with regard to the tier designation unit 41, the input unit 16 can be configured by a member other than a touchscreen. In this case, the tier designation unit 41 can be configured to receive an operation in accordance with the type of input unit 16, for example, to receive an input operation such as a click operation to the information displayed on the display unit 17, or an input operation using a keyboard.

In the above embodiment, the display forms are represented in gray scales by the status display controller 1; however, the display forms are not limited thereto. For example, the display forms can be represented in tones by the status display controller 1. In this case, the display form determination unit 43 determines any one value from among the binary tones showing whether the real status coincides with the ideal status for the items of the lowermost tier; and determines a tone of an item of a predetermined tier, based on incorporation of each tone of N items of the lower tier.

As a result, the display forms of items of a predetermined tier are represented in tones; therefore, gradation expression is allowed for each status, and visual recognition is facilitated for a user (administrator). In this case as well, the administrator or the like can intuitively and immediately understand how the real status specifically differs from the ideal status.

In the abovementioned embodiment, a touchscreen tablet is described as an example of the status display controller 1 to which the present disclosure is applied; however, the present disclosure is not limited thereto in particular.

For example, the present disclosure can be applied to electronic devices having a display function in general. More specifically, for example, the present disclosure can be applied to a laptop personal computer, a television receiver, a video camera, a portable navigation device, a cellular telephone device, a portable gaming machine, etc.

The sequence of processing described above can be executed by hardware and/or software.

In other words, the functional configuration shown in FIG. 2 is merely an exemplification, and is not limited thereto in particular. In other words, it is sufficient for the status display controller 1 to include a function capable of executing the aforementioned sequence of processing as a whole; and which functional block should be used to implement the function is not particularly limited to the example shown in FIG. 2.

A single functional block may be configured by a single piece of hardware, a single piece of software, or a combination thereof.

In a case in which a sequence of processing is executed by software, a program configuring the software is installed from a network or a recording medium into a computer, etc.

The computer may be a computer incorporated into specialized hardware. The computer may be a computer such as a general-purpose personal computer capable of executing various functions by installing various programs.

The storage medium containing such a program is not only configured by the removable medium 31 shown in FIG. 1 distributed separately from the device main body for supplying the program to the user, but may also be configured by a storage medium or the like provided to the user in a state incorporated in the device main body in advance. The removable medium 31 is configured by, for example, a magnetic disk (including a floppy disk), an optical disk, a magnetic optical disk, or the like. The optical disk is configured by, for example, a CD-ROM (Compact Disk-Read Only Memory), a DVD (Digital Versatile Disk), or the like. The magnetic optical disk is configured by an MD (Mini-Disk) or the like. The storage medium provided to the user in a state incorporated in the device main body in advance is configured by, for example, the ROM 12 shown in FIG. 1, a hard disk included in the storage unit 18 shown in FIG. 1 or the like, in which the program is recorded.

In the present specification, the steps describing the program recorded in the storage medium include not only the processing executed in a time series following this order, but also processing executed in parallel or individually, which is not necessarily executed in a time series.

What is claimed is:

1. A status display controller for executing control of displaying real status for respective items time-divided on the basis of a predetermined time unit, the status display controller comprising:
a tier designation unit for designating a tier of time units that are tiered such that a predetermined tier is composed of N time units of a lower tier;
a status acquisition unit for acquiring real status for each time unit of the tier designated by the tier designation unit;
a display form determination unit for determining a display form of an item for each time unit of the tier designated by the tier designation unit, based on difference between the real status and ideal status acquired by the status acquisition unit, and based on display forms of N items of a lower tier; and
a display control unit for executing control such that each item for each time unit of the tier designated by the tier designation unit is displayed in the display form determined by the display form determination unit.

2. The status display controller according to claim 1,
wherein the display form is displayed in a tone or gray scale,
wherein the display form determination unit determines any one value from among binary tones or gray scales showing whether the real status coincides with the ideal status for items of a lowermost tier, and
wherein the display form determination unit determines a tone or a gray scale of an item of a predetermined tier, based on incorporation of each tone or each gray scale of N items of a lower tier.

3. A status display control method executed by a status display controller for executing control of displaying real status for respective items time-divided on the basis of a predetermined time unit, the status display control method comprising:
a tier designating step of designating a tier of time units that are tiered such that a predetermined tier is composed of N time units of a lower tier;
a status acquiring step of acquiring real status for each time unit of the tier designated in the tier designating step;
a display form determining step of determining a display form of an item for each time unit of the tier designated in the tier designating step, based on difference between the real status and ideal status acquired in the status acquiring step, and based on display forms of N items of a lower tier; and
a display controlling step of executing control such that each item for each time unit of the tier designated in the tier designating step is displayed in the display form determined in the display form determining step.

4. A recording medium storing a program for causing a computer, which executes control of displaying real status for respective items time-divided on the basis of a predetermined time unit, to function as:
a tier designation unit for designating a tier of time units that are tiered such that a predetermined tier is composed of N time units of a lower tier;
a status acquisition unit for acquiring real status for each time unit of the tier designated by the tier designation unit;
a display form determination unit for determining a display form of an item for each time unit of the tier designated by the tier designation unit, based on difference between the real status and ideal status acquired by the status acquisition unit, and based on display forms of N items of a lower tier; and
a display control unit for executing control such that each item for each time unit of the tier designated by the tier designation unit is displayed in the display form determined by the display form determination unit.
